(19) United States
(12) Patent Application Publication
(10) Pub. No.: US 2011/0282831 A1
(43) Pub. Date: Nov. 17, 2011

(54) DEVICE INCLUDING A VIRTUAL DRIVE SYSTEM

(75) Inventors: Chun-Ming Huang, Hsinchu City (TW); Chien-Ming Wu, Hsinchu City (TW); Wei-De Chien, Hsinchu City (TW); Wei-Chang Tsai, Hsinchu City (TW); Chin-Long Wey, Hsinchu City (TW); Yu-Tsang Chang, Hsinchu City (TW)

(73) Assignee: National Chip Implementation Center National Applied Research Laboratories, Hsinchu City (TW)

(21) Appl. No.: 12/821,163

(22) Filed: Jun. 23, 2010

(30) Foreign Application Priority Data
May 12, 2010 (TW) 099115044

(51) Int. Cl. G06F 17/30; G06F 7/00

(52) U.S. Cl. 707/609; 707/E17.01; 707/E17.031

(57) ABSTRACT

A device including a virtual drive system is provided. An image file can be identified as an ordinary physical disk drive via the device. The device includes a storage unit, an image management unit, and an operating-system interface. The storage unit is configured to store at least one image file. The image management unit includes an image management program which can manage the image files to be selected. The operating-system interface is connected by electrical signals with an operating-system apparatus and is controlled by the image management program to send a controlling signal to the operating-system apparatus. Therefore, the operating-system apparatus can identify as many physical disk drives as the corresponding selected image files.

### BACKGROUND OF THE INVENTION

1. Technical Field

The present invention relates to peripheral devices for personal computers, and more particularly, to a device including a virtual drive system that stores at least one image file.

2. Description of Related Art

Compact discs (CD) are characterized by their low cost, compactness, high capacity, and high speed of mass production. Hence, more than a decade ago, compact discs started to substitute for conventional magnetic discs and became an important type of carrier for commercially available package software. However, retrieving data from a database stored in a compact disc requires putting the compact disc in a CD-ROM drive and then reading the data from the compact disc by using the CD-ROM drive, which results in various drawbacks. For instance, compact discs are likely to be scratched while being inserted into or withdrawn from CD-ROM drives. As a result, data cannot be read from the compact disc, if the scratches in the compact disc are numerous or deep.

In a scenario where a user has to carry or use a plurality of compact discs, for example, in order to execute software installation, system restoring, or data backup, or play audiovisual content, the user has to put the compact discs into the disk drive one by one, which is quite inconvenient to the user. At present, a commercially available device allows a user to put a plurality of compact discs into a disk drive at the same time. Then the user can select one of the compact discs to be played. However, the device has a number of drawbacks including a plethora of constituent elements, bulkiness, low portability, vulnerability after extended use, and a high risk of malfunctioning when a compact disc is caught in the device and is subsequently damaged.

At present, there are several types of commercially-available application software for a virtual drive system, which is configured to store data in an operating-system apparatus, such as a computer. This data previously stored in a compact disc can now be directly stored into one complete image file, which simulates the former situation of a compact disc being placed in a physical disk drive, without the necessity of a physical disk drive. Such software allows the user to conveniently transport data without the necessity of a disk drive and its accompanying drawbacks.

However, the aforesaid application software has its disadvantages. For example, a special version of the aforesaid virtual drive system application software cannot be executed without an operating system or an operating-system apparatus. Hence, the aforesaid application software cannot be executed in the absence of an operating system or in conjunction with an embedded system. There is also a technique known as the “Live-USB” technique which is disadvantaged by its narrow scope in application, in which the “Live-USB” is forced to store the settings of a system in order to execute the start-up process of a computer and is unable to support various kinds of systems at the same time.

### BRIEF SUMMARY OF THE INVENTION

The present invention relates to a device including a virtual drive system. The device allows data to be stored, in the form of an image file, in the device, but does not require execution of a corresponding application program by an operating-system apparatus. Given an interface protocol of a firmware layer, the operating-system apparatus identifies the image file as a physical disk drive. In so doing, operation can begin right away without waiting for the certification of the operating system, thereby preventing the virtual drive system application software from being dependent on the operating system. Also, as disclosed in the present invention, the device is configured to store a plurality of image files therein. By contrast, the conventional technique “Live-USB” only allows a single system to be loaded and executed. Hence, the present invention exceeds the prior art in portability and facility.

In order to achieve the above and other objectives, the present invention provides a device including a virtual drive system, comprising: at least one storage unit storing therein at least one image file; an image management unit having an image management program for managing the image files and selecting at least one of the image files; and an operating-system interface connected by electrical signals to an operating-system apparatus and controlled by the image management program to send a controlling signal to the operating-system apparatus, thereby allowing the operating-system apparatus to identify and choose physical disk drives corresponding to the selected image files.

Implementation of the present invention involves at least the following inventive steps:

1. The contents of a compact disc can be completely stored in the form of an image file to thereby dispense with the need for compact discs and accompanying damage to the compact disc.

2. No specific reading software needs to be installed in an operating-system apparatus.

3. Loading data from a plurality of compact discs concurrently, so as to enhance ease of use.

4. After a device including a virtual drive system has been connected to the operating-system apparatus, the operating-system apparatus identifies the image file as a physical disk drive and then read data from the image file according to the settings of the device. Hence, the present invention overcomes a drawback of the prior art, that is, operating system-dependency of virtual drive system application software.

5. The device is connected to the operating-system apparatus by means of a cable or wirelessly, thus demonstrating ease of use.

6. Wide application, such as the settings for starting the operating-system apparatus, backup, consumer electronic product industry, or audiovisual industry. Regarding the settings for starting the operating-system apparatus, to allow a system to be installed in the operating-system apparatus or to maintain the operating-system apparatus, the device of present invention is connected to a computer and then switched to intended image files. Hence, the device of the present invention dispenses with the necessity of carrying compact discs or any other storage apparatuses or incessantly changing the compact discs or storage apparatuses. Accordingly, the device of the present invention greatly enhances facility in use.

### BRIEF DESCRIPTION OF THE SEVERAL VIEWS OF THE DRAWINGS

The objectives and advantages of the present invention are described in detail in the preferred embodiment of the present invention so as to enable persons skilled in the art to gain insight into the technical disclosure in the present invention, implement the present invention accordingly, and readily understand the objectives and advantages of the present invention by making reference to the disclosure contained in the specification, the claims, and the drawings of the present invention.

FIG. 1 is a schematic view of an embodiment of a device including a virtual drive system according to the present invention.

### DETAILED DESCRIPTION OF THE INVENTION

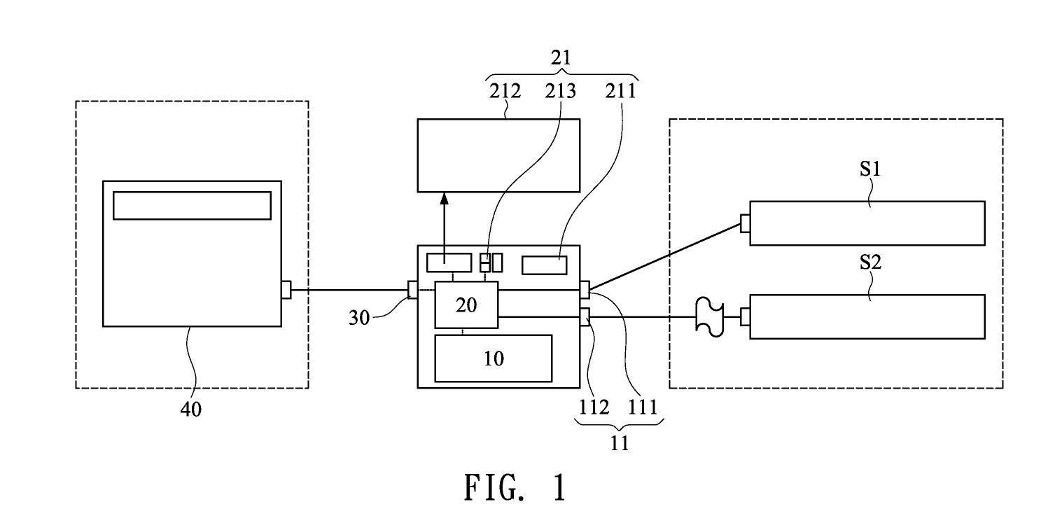

Referring to FIG. 1, in an embodiment of the present invention, a device including a virtual drive system comprises at least one storage unit 10, an image management unit 20, and an operating-system interface 30.

The at least one storage unit 10 is configured to store at least one image file. The storage unit 10 is a built-in storage component, such as a hard disk drive, a solid-state hard disk drive, or a flash memory component.

The image management unit 20 has an image management program for managing the image files and selecting at least one of the image files.

The operating-system interface 30 is connected by electrical signals with an operating-system apparatus 40 and is controlled by the image management program to send a controlling signal to the operating-system apparatus 40. Hence, the operating-system apparatus 40 can identify physical disk drives corresponding to the selected image files.

In the embodiment, a user can store the contents of a drive in the storage unit 10 in the form of image files, and the image management program in the image management unit 20 manages the image files thus stored. Connecting the device to the operating-system apparatus 40 requires the connection by electrical signals of the operating-system interface 30 to the operating-system apparatus 40. The controlling signal which is controllably generated by the image management program is sent to the operating-system apparatus 40. As a result, the operating-system apparatus 40 is connected to the intended image files. Thus, the operating-system apparatus 40 can identify as many physical disk drives as the corresponding image files, and then continue to execute the program of the selected image files. Therefore, the device including a virtual drive system according to the present invention dispenses with the installation of reading software in the operating-system apparatus 40 and advantageously includes a virtual drive.

Furthermore, the storage unit 10 comprises at least one external storage interface 11. The external storage interface 11 further comprises a local storage apparatus interface 111 and a remote storage apparatus interface 112. The local storage apparatus interface 111 is a serial ATA interface, a SCSI interface, a USB interface, or an IEEE1394 interface. The remote storage apparatus interface 112 is a cable network interface or a wireless network interface.

The external storage interface 11 enables flexible expansion of the capacity of the storage unit 10, and allows users to sort data or store data conveniently. For example, an operating program required for the operating-system apparatus 40 can be disposed inside a storage apparatus 51, and an audiovisual program can be disposed inside another storage apparatus S2. Alternatively, both the operating program and the audiovisual program can be disposed inside the same storage apparatus, but the present invention is not limited thereto. To reinstall the operating system, a user can directly connect the storage apparatus 51 storing the operating system to the external storage interface 11. Hence, in the embodiment, an installation process is carried out step by step to thereby dispense with repeated replacement of compact discs and enhance facility in use.

The operating-system interface 30 is a USB interface or an IEEE1394 interface. The two interfaces are transmission interfaces in wide usage. The operating-system interface 30 is connected by electrical signals with the operating-system apparatus 40. Hence, conveniently, it is unnecessary to install an additional interface on the operating-system apparatus 40.

The image management unit 20 further comprises a man-machine interface 21. The man-machine interface 21 comprises a display unit 211, a management checklist unit 212, and a command input unit 213. The management checklist unit 212 is configured to identify the image files in the storage unit 10 and establish a management checklist to be displayed by the display unit 211. The command input unit 213 is configured to select at least one image file from the management checklist.

The man-machine interface 21 is configured in such a manner that a user can directly give a command to the image management unit 20 by means of the command input unit 213.

The management checklist unit 212 is configured to established the management checklist. The established management checklist is displayed by the display unit 211. As a result, users can select an image file without memorizing the filename of the image file.

The display unit 211 and the command input unit 213 are built in the device including a virtual drive system. The display unit 211 and the command input unit 213 interact with the management checklist unit 212 by means of a protocol, so as to enhance the ease of use of the management checklist unit 212. Also, in the embodiment, once the device of the present invention is connected to the operating-system apparatus 40, a monitor of the operating-system apparatus 40 can function as the display unit 211, and a keyboard of the operating-system apparatus 40 can function as the command input unit 213, so as to enhance ease of use of the device of the present invention.

In the embodiment, at least one compact disc is stored, in the form of an image file, in the storage unit 10. It is unnecessary for the operating-system apparatus 40 to execute a corresponding application program, because the operating-system apparatus 40 can identify the image file as a physical disk drive. Hence, the device of the present invention advantageously prevents a virtual drive system application software from being dependent on an operating system.

In conclusion, in the embodiment of the present invention, given an interface protocol of a firmware layer, the operating-system apparatus 40 identifies an image file as a physical disk drive. In so doing, the device of the present invention has the following advantages. Users do not need to inconveniently carry an excess of compact discs. Compact discs are thus protected against scratches. It is not necessary to install a specific reading package software in the operating-system apparatus 40. Data can be concurrently loaded from a plurality of compact discs. After the device of the present invention has been connected to the operating-system apparatus 40, the operating-system apparatus 40 recognizes the device, and then the operating-system apparatus 40 can identify as many physical disk drives as the corresponding selected image files. Afterward, the operating-system apparatus 40 reads data from the intended image file according to the settings of the device. Hence, the device of the present invention prevents the virtual drive system application software from being dependent upon the operating system. Last but not least, the present invention has wide application, such as installation and maintenance of information systems, and functions as a substitute for external CD-ROM drives for use with computers or various consumer electronic products.

The foregoing embodiment is provided to illustrate and disclose the technical features of the present invention so as to enable persons skilled in the art to understand the disclosure of the present invention and implement the present invention accordingly, and is not intended to be restrictive of the scope of the present invention. Hence, all equivalent modifications and variations made to the foregoing embodiment without departing from the spirit and principles in the disclosure of the present invention should fall within the scope of the invention as set forth in the appended claims.

What is claimed is:

1. A device including a virtual drive system, comprising:
at least one storage unit storing therein at least one image file;
an image management unit having an image management program for managing the image files and selecting at least one of the image files; and
an operating-system interface connected by electrical signals to an operating-system apparatus and controlled by the image management program to send a controlling signal to the operating-system apparatus, thereby allowing the operating-system apparatus to identify physical disk drives corresponding to the selected image files.

2. The device of claim 1, wherein the storage unit is a built-in storage component.

3. The device of claim 2, wherein the built-in storage component is a hard disk drive, a solid-state hard disk drive, or a flash memory component.

4. The device of claim 1, wherein the storage unit comprises at least one external storage interface.

5. The device of claim 4, wherein the external storage interface is a local storage apparatus interface or a remote storage apparatus interface.

6. The device of claim 5, wherein the local storage apparatus interface is a serial ATA interface, a SCSI interface, a USB interface, or an IEEE1394 interface.

7. The device of claim 5, wherein the remote storage apparatus interface is a cable network interface or a wireless network interface.

8. The device of claim 1, wherein the operating-system interface is a USB interface or an IEEE1394 interface.

9. The device of claim 1, wherein the image management unit has a man-machine interface comprising: a display unit; a management checklist unit for identifying the image files in the storage unit and creating a management checklist to be displayed by the display unit; and a command input unit for selecting at least one of the image files from the management checklist.

10. The device of claim 9, wherein the display unit and the command input unit are built in the device.

11. The device of claim 9, wherein the display unit and the command input unit are disposed in the operating-system apparatus and interact with the management checklist unit by means of a protocol.
